(19) United States
(12) Patent Application Publication
(10) Pub. No.: US 2015/0127840 A1
(43) Pub. Date: May 7, 2015

(54) METHOD FOR ESTABLISHING COMMUNICATION WITH A GUEST DEVICE ON A NETWORK

(71) Applicant: Gerard Lighting Pty Ltd, Rose Park (AU)

(72) Inventors: Darren Snodgrass, South Australia (AU); Clive Haskins, Walkley Heights (AU)

(73) Assignee: Gerard Lighting Pty Ltd, Rose Park (AU)

(21) Appl. No.: 14/134,174

(22) Filed: Dec. 19, 2013

(30) Foreign Application Priority Data
Nov. 1, 2013 (AU) 2013904238

(51) Int. Cl. H04L 29/12

(52) U.S. Cl. CPC H04L 61/2076
USPC 709/228

(57) ABSTRACT

A method of establishing communication with a guest device on a network, where the guest device may not have access to network services such as DNS. The guest device ascertains its own network address and encodes it in a QR code or the like which is read by a second device and decoded to ascertain the network address of the guest device. The network address is then used to establish communication between the second device and the guest device.

### FIELD OF THE INVENTION

The present invention relates to a method for establishing communication with a guest device on a network. Whilst the invention is described in the context of an IP (Internet Protocol) network it is also applicable to other types of networks.

### BACKGROUND TO THE INVENTION

LANs (Local Area Networks) are often exploited for temporary communications needs. This is readily accommodated where a guest device wishes to establish communication outside of the LAN, but not so when a second device within the LAN wishes to instigate communication with the guest device as the IP address of the guest device is unknown.

There are several well known mechanisms for establishing the network address of a device such as DNS (Domain Name System) and Dynamic DNS, however these require networking infrastructure which may not be present, or may not be able to be accessed or configured as needed.

Alternative solutions include using a known central server as a proxy with a known or discoverable IP address, using a static IP address for the guest device, or using UDP (User Datagram Protocol) broadcast packets for the two devices to discover each other. Such solutions again, may not be present, or may not be able to be accessed or configured as needed.

Further possible solutions include sending the network address via e-mail, SMS, Bluetooth, Infrared or an audio modem. Again such methods rely on hardware or infrastructure which may not be available.

The object of this invention is to provide a method for establishing communication with a guest device over a network that alleviates the above problems, or at least provides the public with a useful alternative.

### SUMMARY OF THE INVENTION

In a first aspect the invention comprises a method of establishing communication between a first device and a second device on a network, comprising the first device ascertaining its own network address, the first device encoding and displaying its network address in a visible format, the second device optically reading and decoding the network address of the first device, and the second device using the network address of the first device to establish communication with the first device over the network.

Preferably the network address of the first device is encoded using a QR code or a bar code.

Preferably the network address of the first device is displayed as text and decoded by the second device using optical character recognition.

In preference the network address is displayed using a temporally varying image.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to drawings as follows.

FIG. 1 is a network diagram of a system in which the method of the present invention may be used.

FIG. 2 is a flow chart of the method of the invention.

### DETAILED DESCRIPTION OF THE INVENTION

The invention provides a method for establishing communication with a guest server device on a network. As a guest on a network a device can ascertain its own network address, but other devices may or may not be able to ascertain the address of the guest device depending on the available network services. To provide a certain method of ascertaining the address, the guest server device visually displays its network address on a monitor in the form of a QR (Quick Response) code or the like. This can then be read by a second client device and used to establish communication between the second client device and the guest server device. The network itself is thus not used to convey the address of the guest server to the client device and thus any limitations of the network in providing services are irrelevant. In a typical application the guest server device is a PC providing a web server application and the second client device is a mobile device such as a smart phone running a web browser application. The smart phone captures the QR code and launches the web browser using a network address from the QR code. Alternatively the guest server device and/or the second client device may run a dedicated application. Dedicated hardware may also be used for the guest server device and/or the second client device. The second client device may also be a guest to the network, but as it initiates the communication with the guest server device it will inherently provide its own address to the guest server device, assuming IP or a similar protocol is used.

The network address displayed is typically the IP address of the guest server and may also include protocol, port and/or path information. On non-IP networks an address appropriate to the relevant network protocol is displayed.

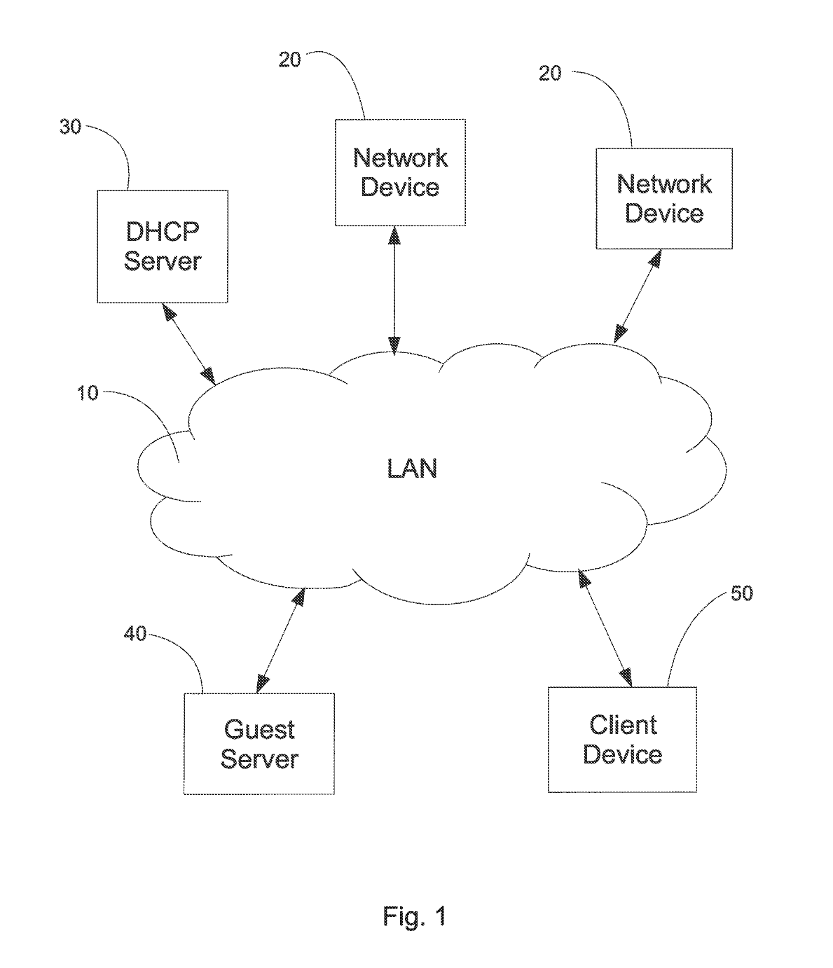

The context of the invention is shown in FIG. 1 in which a LAN 10 is used to connect together network devices 20. The LAN may be a combination of wired and wireless infrastructure and is optionally configured by a DHCP (Dynamic Host Configuration Protocol) server 30. A guest server 40 is connected to the LAN as is a client device 50. If a DHCP server is not present then the devices may obtain their IP address by other methods as is well known in the art such as link-local addressing.

The invention is also applicable to situations where the server 40 is normally connected to the LAN 10 instead of being a guest to the LAN. The client device 50 may also be a guest to the LAN or permanently connected. The invention is also applicable to ad hoc networks which could be as simple as a the server 40 and client device 50 both being in the form of mobile computing devices (e.g. laptop, tablet or smart phone) with either device acting as a Wi-Fi hotspot.

The invention provides a method for the client device 50 to establish communication with the guest server 40. An example scenario requiring the method is the commissioning of a distributed lighting system in a building where the guest server 40 is a master controller for the lighting system and the client device 50 is a smart phone carried around the building by a technician to aid in commissioning the lighting system. The technician needs to establish communication with the master controller in order to control the lighting system or to provide feedback as to the operation of various lights. As the guest server is not a normal part of the LAN its network address is not known in advance for use by the client device. The guest server's network address must be determined and entered into the client device to allow communication to be established. Without the aid of the invention this could be achieved by means as discussed in the background, however these may not be available or desired. The most likely scenario is that the technician would need to type the network address of the guest server into the client device which is burdensome and easy to get wrong.

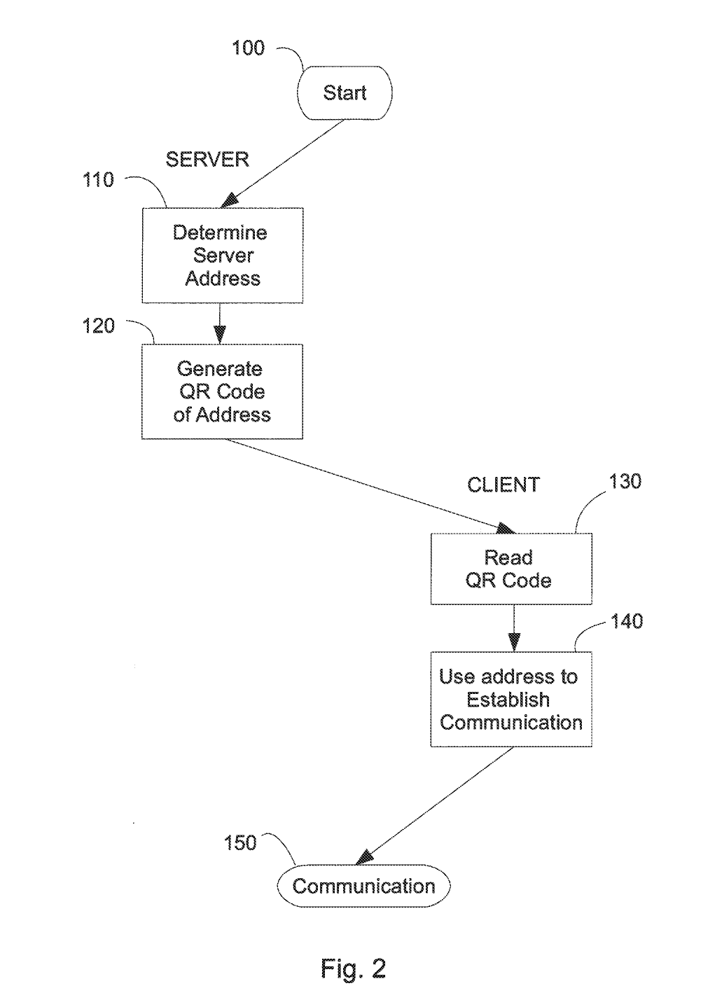

In a preferred embodiment the method of establishing communication between a guest server 40 and a client device 50 is shown in the flow chart of FIG. 2.

At the start 100, the guest server 40 joins the LAN 10 and ascertains its network address. This would typically be achieved using DHCP, but may also be a permanent IP address or self allocated using link-local addressing.

At step 110 a server application running on the guest server 40 determines the guest server's network address. Such a step is well known in the art.

At step 120 the server application generates a QR code including the network address of the guest server and displays it in a visible format, typically on a monitor. Typically the network address will be included in a URL (Uniform Resource Locator) used to access the server application.

At step 130 the client device 50 reads the QR code. This may be performed by a dedicated application or with a generic QR code reading application which in turn launches a web browser or dedicated client application.

At step 140 the network address is used by the client application or web browser to establish communication with the server application running on the guest server.

At step 150 communication between the guest server and client device may continue as desired.

The method may take the form of several alternative embodiments.

In a first alternative embodiment the QR code is printed instead of being displayed on a monitor.

In a further embodiment the network address is displayed as text and decoded using OCR (Optical Character Recognition) technology.

In a further embodiment a linear bar code is used instead of a QR code. Well known bar code formats can encode up to 128 characters which is sufficient to encode a URL.

In another further embodiment a standard 2D bar code is used.

In still further embodiments custom bar codes may be used.

In yet further embodiments the network address is encoded in a temporally varying image. The image may be a series of black and white or even colour images. The images may also include spatial variations to encode the network address.

In the various embodiments the common element is that the network address is conveyed by visual means between the guest server and client device and not over the network to which they wish to communicate over.

The reader will now appreciate the present invention which provides a method for establishing communication between a client device and a guest server on a network.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A method of establishing communication between a first device and a second device on a network, comprising:
the first device ascertaining its own network address;
the first device encoding and displaying its network address in a visible format;
the second device optically reading and decoding the network address of the first device; and
the second device using the network address of the first device to establish communication with the first device over the network.

2. The method as in claim 1, wherein the network address of the first device is encoded using a bar code.

3. The method as in claim 1, wherein the network address of the first device is encoded using a QR code.

4. The method as in claim 1, wherein the network address of the first device is displayed as text and decoded by the second device using optical character recognition.

5. The method as in claim 1, wherein the network address is displayed using a temporally varying image.
